(19) United States
(12) Patent Application Publication
(10) Pub. No.: US 2013/0238185 A1
(43) Pub. Date: Sep. 12, 2013

(54) CAR VIDEO DEVICE ENABLING WIRELESS TRANSMISSION TO AND FROM PORTABLE COMMUNICATION DEVICE

(71) Applicant: CHENG-YI CHO, New Taipei City (TW)

(72) Inventor: CHENG-YI CHO, New Taipei City (TW)

(21) Appl. No.: 13/413,924

(22) Filed: Mar. 7, 2012

(51) Int. Cl. G06F 7/00

(52) U.S. Cl. 701/36

(57) ABSTRACT

A car video device enabling wireless transmission to and from portable communication device includes an image processing unit, a packet signal input terminal, a driving recorder unit, a control unit, a wireless signal transmission unit, and a power input terminal. The control unit can receive signals from the image processing unit, the packet signal input terminal and the driving recorder unit, and transmits the received signals to the wireless signal transmission unit, which then wirelessly transmits the signals to a portable communication device, such as a smart mobile phone, a tablet computer or a portable computer. Therefore, the portable communication device may be directly used in the car for displaying image signals and serve as a menu operation host of various in-car safe driving devices, and it is not necessary to additionally mount an LCD display in the car.

### FIELD OF THE INVENTION

The present invention relates to a car video device that enables wireless transmission to and from a portable communication device, so that signals from various in-car safe driving devices can be wirelessly transmitted to the portable communication device, on a screen of which the signals can be displayed and a user may do menu operation.

### BACKGROUND OF THE INVENTION

To help to clarify a driver's legal responsibility for an accident, it is now very popular to install a driving recorder unit in a car mainly for capturing images in front of the car. And, to ensure the safety in driving, it is also very often to install a camera at a rear side of the car for automatically capturing images behind the car when the driver reverses the car. There are also car owners who mount a liquid crystal display television (LCD TV) in the car for receiving digital TV signals.

All the above-mentioned devices require a screen to display images. Unfortunately, the LCD screen often attracts a thief to forcefully open a car door or break a car window to steal the LCD screen along with other valuable articles in the car. That is, the LCD screen mounted in the car just forms a car thief's target. Therefore, most drivers would hide the LCD screen or dismount and carry the LCD screen along with them when they leave the car. Some drivers even decide not to install such devices that are actually important for safe driving.

Most of the currently available cars now have a full/multiple functional electronic controlling system using a controller area network, which is briefly referred to as CANBUS. By using CANBUS, when any of the large number of electronic parts and components and sensors provided at different positions in the car is abnormal or failed, a signal will immediately be transmitted to a car computer and be recorded down. In some serious cases, the car is forced into a protected mode or even stopped from operating. The maintenance person can link the car computer system with an external computer system, so that all data stored in the car computer are displayed on the external computer's screen to enable quick troubleshooting and correct repair or maintenance. The use of CANBUS enables easy and correct car troubleshooting. In the case there is a computer device installed in the car, the states of various parts and components of the car may also be directly displayed on the computer screen for the driver to have an idea about the car's current conditions before sending the car to an auto repair shop.

In view that the LCD screen provided in a car is easily stolen by a thief, it is therefore tried by the inventor to develop a car video device that utilizes a portable communication device to replace the LCD screen in the car for displaying images captured by various in-car safe driving devices.

### SUMMARY OF THE INVENTION

A primary object of the present invention is to provide a car video device that enables wireless transmission to and from a portable communication device, so that the portable communication device can display images output from various in-car devices and serve as a menu operation host of these in-car devices.

To achieve the above and other objects, the car video device enabling wireless transmission to and from a portable communication device according to an embodiment of the present invention includes an image processing unit capable of receiving image information from cameras inside and outside a car, and converting the received image information into digital signals for outputting; a packet signal input terminal connected to a communicator of a vehicle area network for receiving packet signals transmitted over the vehicle area network; a driving recorder unit for recording all images, dates and time, as well as driving speeds in the process of driving a car; a control unit capable of receiving and storing image signals output to it from the image processing unit, and outputting image signals captured by a related one of the cameras according to a reverse signal or a turning light signal in the received packet signals; the control unit also receiving signals from the driving recorder unit and accordingly outputting the images stored in the driving recorder unit; a wireless signal transmission unit capable of receiving signals output by the control unit and wirelessly transmitting the received signals to a portable communication device, and the wireless signal transmission unit also being able to receive wireless signals transmitted from the portable communication device to do menu operation for accessing signals stored in and output by the control unit; and a power input terminal connected to an in-car power source for inputting power supply that is needed by all the above units to operate normally.

In the car video device of the present invention, in the case a reverse signal is acquired from the packet signals, the control unit first outputs image signals captured by a camera arranged at a rear side of the car when the car is in the reverse gear. On the other hand, in the case a turning light signal is acquired from the packet signals, the control unit first outputs image signals captured by a camera arranged at a left or a right side of the car.

The car video device of the present invention further includes a digital TV receiver unit. Signals received by the digital TV receiver unit are transmitted to the control unit, which further transmits the received signals to the wireless signal transmission unit for wirelessly transmitting to the portable communication device.

The car video device of the present invention further includes a Bluetooth transmission unit, which is connected to an in-car stereo.

In the car video device of the present invention, the portable communication device can be a smart mobile phone, a tablet computer, or a portable computer.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a car video device enabling wireless transmission to and from portable communication device according to a first embodiment of the present invention;

FIG. 2 is a perspective view of the car video device enabling wireless transmission to and from portable communication device according to the present invention;

FIG. 3 is a schematic plan view of a tablet computer; and

FIG. 4 is a block diagram of a car video device enabling wireless transmission to and from portable communication device according to a second embodiment of the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

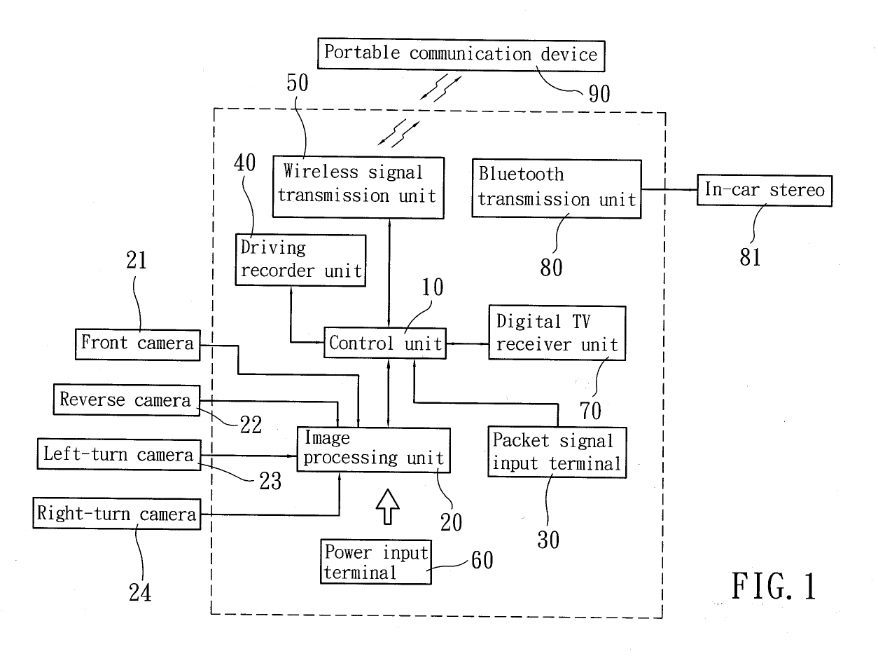

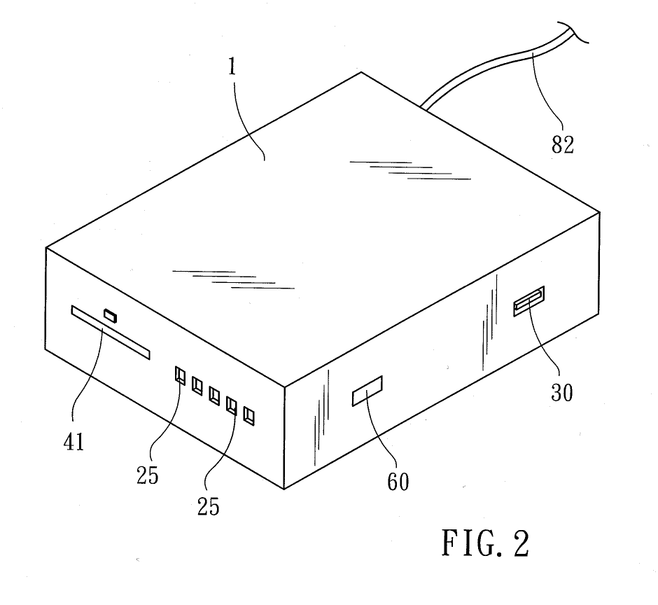

Please refer to FIGS. 1 and 2. A car video device enabling wireless transmission to and from portable communication device according to a first embodiment of the present invention includes a control unit 10, an image processing unit 20, a packet signal input terminal 30, a driving recorder unit 40, a wireless signal transmission unit 50, and a power input terminal 60. The control unit 10 receives signals from the image processing unit 20, the packet signal input terminal 30 and the driving recorder unit 40, and transmits the received signals to the wireless signal transmission unit 50, from which the signals are further output to a portable communication device 90. The portable communication device 90 can be a smart mobile phone, a tablet computer, or a portable computer.

The image processing unit 20 receives image information from several cameras inside and outside a car that uses the car video device of the present invention, and converts the received image information into digital signals for outputting to the control unit 10. The cameras include a front camera 21, a reverse camera 22, a left-turn camera 23, and a right-turn camera 24 arranged at a front position, a rear position, a left side, and a right side of the car body, respectively.

The packet signal input terminal 30 can be connected to a communicator of a vehicle area network for receiving packet signals transmitted over the vehicle area network. The car owner can inspect the working conditions of various car parts by viewing the portable communication device 90 to facilitate easy repair and maintenance of the car. The driving recorder unit 40 is mainly used to record all images, dates and time, as well as driving speeds in the process of driving the car.

The control unit 10 receives and stores image signals transmitted to it from the image processing unit 20, and outputs the image signals captured by a related one of the cameras 22, 23, 24 according to a reverse signal or a turning light signal in the received packet signals. The control unit 10 also receives signals from the driving recorder unit 40, and outputs the images stored in the driving recorder unit 40. Herein, the images stored in the driving recorder unit 40 are images captured by the front camera 21.

The wireless signal transmission unit 50 receives signals output by the control unit 10, and wirelessly transmits the received signals to a Wi-Fi certified portable communication device 90. The wireless signal transmission unit 50 can also receive wireless signals from the portable communication device 90 to do menu operation for accessing signals stored in and output by the control unit 10.

The power input terminal 60 can be connected to an in-car power source for inputting power supply that is needed by all the above units to operate normally.

In the case a reverse signal is acquired from the packet signals, the control unit 10 would first output image signals captured by the reverse camera 22 when the car is in the reverse gear, and the driver can view the images of a site behind the car as shown on a screen of the portable communication device 90 to determine whether there is any person, animal or other obstacle behind the car, so as to reverse the car safely and avoid any undesired condition during, for example, reversing into the garage.

On the other hand, in the case a turning light signal is acquired from the packet signals, the control unit 10 would first output image signals captured by the left-turn camera 23 or the right-turn camera 24, and the driver can view the images of road behind the car as shown on the screen of the portable communication device 90 and determine whether it is safe to make a left turn or a right turn during driving. When a left turning light blinks, the images captured by the left-turn camera 23 would be displayed on the screen of the portable communication device 90; and when a right turning light blinks, the images captured by the right-turn camera 24 would be displayed on the screen of the portable communication device 90. Therefore, the driver needs only to watch the screen of the portable communication device 90 to know whether there is any car coming from behind to overcome the problem of dead viewing angle as found in using rearview mirrors, making driving safer.

The present invention may further include a digital television (TV) receiver unit 70. Signals received by the digital TV receiver unit 70 can be transmitted to the control unit 10, which further transmits the received signals to the wireless signal transmission unit 50 for wirelessly transmitting to the portable communication device 90. The driver or any passenger in the car may watch TV programs simply by selecting “Digital TV” on the portable communication device 90. The driver and the passenger may also switch among different channels and control sound volume and perform other operations on the portable communication device 90.

The present invention may further include a Bluetooth transmission unit 80, which is connected to an in-car stereo 81. The Bluetooth transmission unit 80 is able to receive sound signals from the portable communication device 90 and the received sound signals are output via the in-car stereo 81. With these arrangements, music played on the portable communication device 90 may be output via the in-car stereo 81, and the driver or the passenger may enjoy music with high sound quality without the need of using earphones.

FIG. 2 is a perspective view of the car video device of the present invention. As shown, the car video device includes a case 1. At least four connection ports 25 for camera signal cables are provided on one side of the case 1, so that the front camera 21, the reverse camera 22, the left-turn camera 23, and the right-turn camera 24 can be connected to the connection ports 25. A card slot 41 is also provided on the case 1 for inserting a memory card (not shown), so that data recorded on the driving recorder unit 40 can be transferred to and stored on the memory card. The case 1 is provided with a signal transmission cable 82 for connecting the Bluetooth transmission unit 80 to the in-car stereo 81.

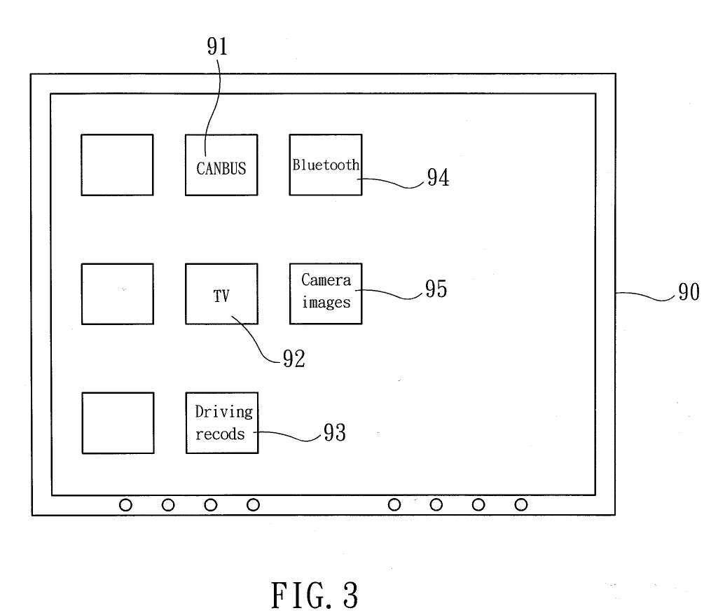

The portable communication device 90 can be a tablet computer as shown in FIG. 3. On the screen of the portable communication device 90, there are shown menu shortcut keys 91, 92, 93, 94 and 95 for signals that are stored in the control unit 10 for outputting. The driver or the passenger may select a desired one of the menu shortcut keys 91-95 on the screen of the portable communication device 90, and video or audio signal contents corresponding to the selected menu shortcut key, such as information from CANBUS-based car control system, images captured by the cameras, digital TV programs, driving records or music, will be displayed on the screen or played via the in-car stereo 81.

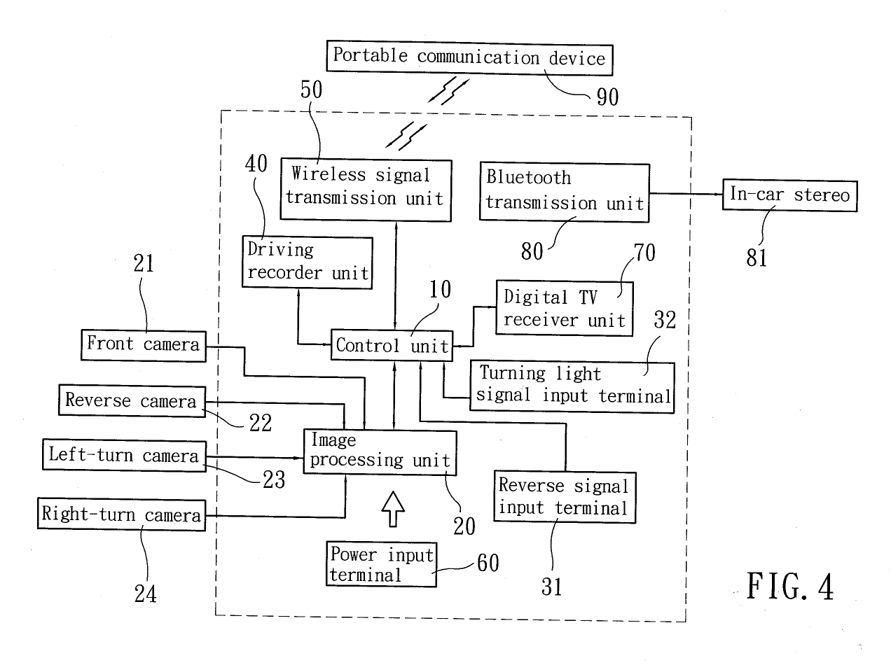

FIG. 4 is a block diagram of a car video device enabling wireless transmission to and from portable communication device according to a second embodiment of the present invention. The car video device in the second embodiment is designed mainly for use on a car without using a CANBUS-based car control system. Compared to the car video device in the first embodiment as illustrated in FIG. 1, the second embodiment omits the packet signal input terminal 30 but additionally includes a reverse signal input terminal 31 and a turning light signal input terminal 32. In the case a reverse signal is received, the control unit 10 would first output image signals captured by the reverse camera 22 when the car is in the reverse gear. On the other hand, in the case a turning light signal is received, the control unit 10 would first output image signals captured by the left-turn camera 23 or the right-turn camera 24.

In brief, with the car video device enabling wireless transmission to and from portable communication device according to the present invention, a portable communication device can be directly used in a car to display images and serve as a menu-operation host of various in-car safe driving devices to save the need of mounting an LCD screen in the car. The driver can conveniently display and view images output by various in-car safe driving devices so long as he or she has a Wi-Fi certified portable communication device. Therefore, the present invention provides high flexibility in use and apparently meets the market demands.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A car video device enabling wireless transmission to and from portable communication device, comprising:
an image processing unit being capable of receiving image information from cameras inside and outside a car, and converting the received image information into digital signals for outputting;
a packet signal input terminal being connected to a communicator of a vehicle area network for receiving packet signals transmitted over the vehicle area network;
a driving recorder unit for recording all images, dates and time, as well as driving speeds in the process of driving the car;
a control unit being capable of receiving and storing image signals output to it from the image processing unit, and outputting image signals captured by a related one of the cameras according to a reverse signal or a turning light signal in the received packet signals; and the control unit also receiving signals from the driving recorder unit and accordingly outputting the images stored in the driving recorder unit;
a wireless signal transmission unit being capable of receiving signals output by the control unit and wirelessly transmitting the received signals to a Wi-Fi certified portable communication device; and the wireless signal transmission unit also being able to receive wireless signals transmitted from the portable communication device to do menu operation for accessing signals stored in and output by the control unit; and
a power input terminal being connected to an in-car power source for inputting power supply that is needed by all the above units to operate normally.

2. The car video device enabling wireless transmission to and from portable communication device as claimed in claim 1, wherein, in the case a reverse signal is acquired from the packet signals, the control unit first outputs image signals captured by a camera arranged at a rear side of the car when the car is in the reverse gear.

3. The car video device enabling wireless transmission to and from portable communication device as claimed in claim 1, wherein, in the case a turning light signal is acquired from the packet signals, the control unit first outputs image signals captured by a camera arranged at a left or a right side of the car.

4. The car video device enabling wireless transmission to and from portable communication device as claimed in claim 1, further comprising a digital TV receiver unit; signals received by the digital TV receiver unit being transmitted to the control unit, which further transmitting the received signals to the wireless signal transmission unit for wirelessly transmitting to the portable communication device.

5. The car video device enabling wireless transmission to and from portable communication device as claimed in claim 1, further comprising a Bluetooth transmission unit, which is connected to an in-car stereo; the Bluetooth transmission unit being able to receive sound signals from the portable communication device and output the received sound signals via the in-car stereo.

6. The car video device enabling wireless transmission to and from portable communication device as claimed in claim 1, wherein the portable communication device is selected from the group consisting of a smart mobile phone, a tablet computer, and a portable computer.

7. A car video device enabling wireless transmission to and from portable communication device, comprising:
an image processing unit being capable of receiving image information from cameras inside and outside a car, and converting the received image information into digital signals for outputting;
a reverse signal input terminal for transmitting a reverse signal;
a turning light signal input terminal for transmitting a turning light signal;
a driving recorder unit for recording all images, dates and time, as well as driving speeds in the process of driving a car;
a control unit being capable of receiving and storing image signals output to it from the image processing unit, and outputting image signals captured by a related one of the cameras on receipt of a reverse signal from the reverse signal input terminal or a turning light signal from the turning light signal input terminal; and the control unit also receiving signals from the driving recorder unit and accordingly outputting the images stored in the driving recorder unit;
a wireless signal transmission unit being capable of receiving signals output by the control unit and wirelessly transmitting the received signals to a Wi-Fi certified portable communication device; and the wireless signal transmission unit also being able to receive wireless signals transmitted from the portable communication device to do menu operation for accessing signals stored in and output by the control unit; and
a power input terminal being connected to an in-car power source for inputting power supply that is needed by all the above units to operate normally.

8. The car video device enabling wireless transmission to and from portable communication device as claimed in claim 7, wherein, in the case a reverse signal is received, the control unit first outputs image signals captured by a camera arranged at a rear side of the car when the car is in the reverse gear.

9. The car video device enabling wireless transmission to and from portable communication device as claimed in claim 7, wherein, in the case a turning light signal is received, the control unit first outputs image signals captured by a camera arranged at a left or a right side of the car.

10. The car video device enabling wireless transmission to and from portable communication device as claimed in claim 7, further comprising a digital TV receiver unit; signals received by the digital TV receiver unit being transmitted to the control unit, which further transmitting the received signals to the wireless signal transmission unit for wirelessly transmitting to the portable communication device.

11. The car video device enabling wireless transmission to and from portable communication device as claimed in claim 7, further comprising a Bluetooth transmission unit, which is connected to an in-car stereo; the Bluetooth transmission unit being able to receive sound signals from the portable communication device and output the received sound signals via the in-car stereo.

12. The car video device enabling wireless transmission to and from portable communication device as claimed in claim 7, wherein the portable communication device is selected from the group consisting of a smart mobile phone, a tablet computer, and a portable computer.
